(19) United States
(12) Patent Application Publication
(10) Pub. No.: US 2018/0141522 A1
(43) Pub. Date: May 24, 2018

(54) Washer fluid vehicle reservoir

(71) Applicant: Toledo Molding & Die, Inc., Toledo, OH (US)

(72) Inventors: Charles David Satarino, Milan, MI (US); Robert Olsen, Monroe, MI (US)

(21) Appl. No.: 15/819,870

(22) Filed: Nov. 21, 2017

Related U.S. Application Data
(60) Provisional application No. 62/425,412, filed on Nov. 22, 2016.

(51) Int. Cl. B60S 1/48; B60S 1/50; B05B 9/04

(52) U.S. Cl. CPC B60S 1/481; F04B 23/02; B05B 9/0423; B60S 1/50

(57) ABSTRACT

Disclosed is an improved vehicle reservoir system employing a single pump with a fluid distribution manifold or linear valve. The manifold is fluidly coupled to the pump, drawing fluid from the reservoir for distribution through multiple outlet ports. In the primary embodiment, a pump would pressurize a cavity of the manifold and fluid would be released through solenoid operated valves located on each outlet port.

### PRIORITY CLAIM

In accordance with 37 C.F.R. §1.76, a claim of priority is included in an Application Data Sheet filed concurrently herewith. Accordingly, the present invention claims priority to U.S. Provisional Patent Application No. 62/425,412, entitled “WASHER FLUID VEHICLE RESERVOIR”, filed Nov. 22, 2016. The contents of which the above referenced application is incorporated herein by reference.

### FIELD OF THE INVENTION

The invention is directed to vehicle reservoirs used for holding washer fluid and, in particular, to an improved vehicle reservoir for storing washer fluid in vehicles servicing more than one location.

### BACKGROUND OF THE INVENTION

Washer fluid can be used on vehicles for various applications. Reservoirs are installed on the vehicles to hold the cleaning fluid, which conventionally was used to clean the exterior of a windshield glazing surface. The washer fluid is nonabrasive and should not leave a coating or residue on the surface. Typically, the fluid consists of distilled water, and various additives can be included to help in insect removal and/or operation in freezing temperatures. Methanol and ethylene glycol are commonly known additives used to lower the freeze temperature of the fluid.

Conventional washer fluid reservoirs are used primarily to hold cleaning fluid for use on a vehicle windshield. The washer reservoir is typically mounted in the engine compartment, and employs an electric pump to transfer fluid upon demand from the reservoir to the windshield.

Vehicle reservoirs have become more complex as they are used to hold the fluid required to clean multiple areas in the vehicle. The reservoirs may be used to service windshields, rear windows, mirrors, headlamps, back-up cameras and numerous other sensors that can benefit from rinsing with washer fluid. Conventional practice is to couple an electric pump operated upon demand for each area to be serviced. An average vehicle may include three or more pumps to deliver fluid to the front windshield, rear window, and headlights. More complex vehicles may further include pumps for directing fluid to cameras and proximity sensors. In many instances, the operator of the vehicle does not frequently use all of the pumps, leading to early degradation and failure of the pumps.

In addition, the use of additional pumps adds cost, complexity, design packaging challenges and potential EMC issues. The pumps are complex and must produce a strong, continuous flow of fluid upon demand, as any delay could result in a safety hazard.

Washer pumps are considered high maintenance items and are known to be a high warranty claim item. What is lacking in the industry is a vehicle reservoir system using, preferably, a single pump, or fewer total pumps to service multiple locations.

### SUMMARY OF THE INVENTION

Disclosed is an improved vehicle washer reservoir system employing a single pump with a fluid distribution manifold. The fluid distribution manifold has a single inlet port that is fluidly coupled to the pump, drawing fluid from the reservoir. The manifold has multiple exit ports, preferably a sized port to each of the vehicle locations. Sized ports allow a larger sized port to be applied to a windshield washing application and smaller diameter ports for sensor cleaning. In the primary embodiment, a pump would pressurize a cavity of the manifold and fluid would be released through solenoid, or otherwise actuated, valves on each exit port. The manifold could be coupled directly to the reservoir or remotely mounted, allowing flexibility in mounting locations. Further, multiple manifolds may be used to accommodate shorter or longer runs from the holding tank to the point of use, or it could be plumbed at the washer reservoir if space allows.

In one embodiment, the manifold has universal mounting tabs or “turkey feet” for support, and is made from two piece injection molded members. The backside of the ports can be bell mouthed for improved entry flow conditions. Exit ports can be molded on both halves to improve directionality. Multiple port sizes allow for different flow rates without the need for flow restrictors.

An objective of the instant invention is to teach a vehicle washer reservoir system that supplants the need for separate pumps for multiple rinsed items with, ideally, a single pump concept; but which may also accommodate a plurality of pumps if the need exists.

Still another objective of the invention is to increase the reliability of a vehicle washing system by using a manifold for distributing fluid to multiple locations using solenoid-like actuated valves.

Yet another objective of the invention is to provide a vehicle washer system that allows remote placement of a fluid reservoir.

Still another objective of the invention is to limit the amount of pumps and associated electromagnetic interference.

Yet another objective of the invention is to provide a pressurized vehicle washer reservoir system to provide immediate flow to safety items versus motor ramp up lag time with a conventional pump.

Yet still another objective of the invention is to provide a lower cost system by eliminating the need for a large number of pumps, yet provide greater reliability by assuring frequent use of the pump, the continued operation of such a pump providing extended life to the pump.

Still yet another objective of the invention is to provide a lower cost washer system with improved reliability by replacing multiple high warranty pumps with a single pump, or fewer number of pumps, that will be used more frequently thereby maintaining valve and seal integrity by usage.

Other objectives and advantages of this invention will become apparent from the following description taken in conjunction with any accompanying drawings wherein are set forth, by way of illustration and example, and certain embodiments of this invention. Any drawings contained herein constitute a part of this specification and include exemplary embodiments of the present invention and illustrate various objects and features thereof.

### BRIEF DESCRIPTION OF THE DRAWINGS

FIG. 1 is a pictorial flow diagram of the washer fluid reservoir system;

FIG. 2 is perspective view of a reservoir manifold; and

FIG. 3 is a perspective view of a flow through reservoir manifold.

### DETAILED DESCRIPTION OF THE PREFERRED EMBODIMENT

Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

Referring to the Figures, set forth is a washer fluid reservoir 10 having a reservoir inlet 12 and a reservoir outlet 14. The interior of the reservoir available for receipt of washer fluid through the reservoir inlet 12 for storing therein. A pump 16 having an inlet 18 is coupled to the reservoir outlet 14 providing a flooded suction to the pump 16. Preferably, a check valve 17 is positioned after the pump 16 to prevent back flow of pumping washing fluid. The preferred embodiment employs a conventional washer pump where are not self priming. For this reason the preferred embodiment places the pump 16 at the bottom of the reservoir so that the pump inlet 18 is always below the reservoir fluid level. In another embodiment, the pump is placed within the reservoir or has an inlet of zero length.

The reservoir can be mounted anywhere in a vehicle, as the single pump allows ease of fluid transfer by providing a pressurize flow of washer fluid. The outlet 20 of the pump allows remote coupling to a manifold 26 by connecting tube 22 through manifold inlet 24. The manifold 26 having a cavity for receipt of fluid transferred from the reservoir 10. The manifold 26 may include a pressure maintaining device such as a bladder 28 to maintain a fluid pressure in the manifold providing instantaneous flow of fluid when needed. The pressure maintaining device can consist of a traditional bladder/compressible gas construct, a compressible, elastic, gas-filled ball, or any other form of non-powered, passive pressure maintaining concept.

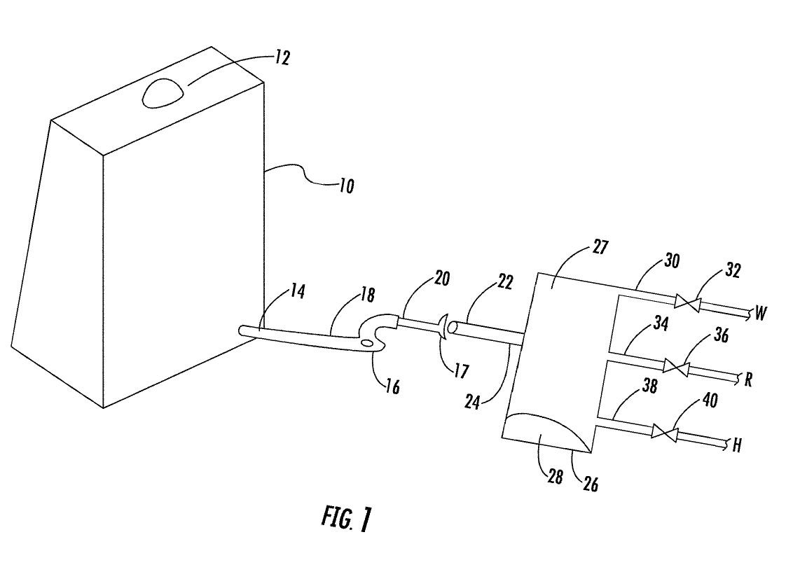

For purposes of illustration, the flow through style manifold 26 of FIG. 1 depicts three outlets. A first outlet 30, having a first diameter size, is coupled to solenoid valve 32. The first outlet 30 may be sized for uninhibited flow to the windshield W. A second outlet 34, having a second diameter, is coupled to a solenoid valve 36. The second diameter may be different than the diameter of the first outlet 30, and coupled to an area of the vehicle that may need cleaning, but not requiring as much fluid as the front windshield. For this example, the second solenoid 36 directs fluid to a rear window R. A third outlet 38, having a third diameter, is coupled to a third solenoid valve 40. The third outlet 38 may be of a reduced size for directing flow to headlights H, which would benefit from flushing with fluid but need not have the flow rate necessary to clean the front windshield or rear window. The outlets are sized to provide a flow rate to best service an individual component. The outlet size may be a function of a flow restrictor, or preferably, the diameter of the outlet is sized to accommodate the flow rate.

While three exit ports are illustrated, additional ports can be used to accommodate most any item on a vehicle that would benefit from a clean rinse with water; this includes the cameras found on modern day vehicles, as well as proximity sensors used for braking and parking, and the numerous sensors envisioned to be required with the evolution of autonomous or semi-autonomous vehicles.

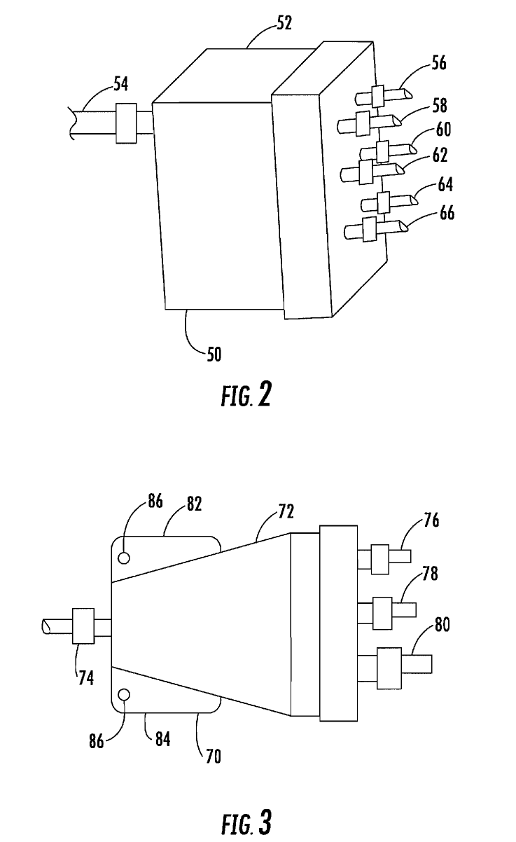

Referring to FIG. 2, depicted is a reservoir style manifold 50 formed from a housing 52 having an inlet 54, upper outlets 56,58; central outlets 60,62; and lower outlets 64,66. The outlets may have different diameters depending on the flow rate required for each item serviced. Similar to the aforementioned embodiment, the outlets all include an electrically operated solenoid secured to each outlet wherein the solenoid is operated to allow fluid flow from the reservoir through a selected manifold outlet. The manifold is fluidly coupled to the outlet of a pump wherein at least outlet is constructed and arranged to deliver washing fluid pressurized by the pump a windshield and additional outlets constructed and arranged to deliver washing fluid to another location on the vehicle that benefits from being rinsed with washing fluid such as the rear windows, side windows, headlamps, cameras, sensors, off road lamps. By use of a solenoid, versus independent pumps, washing fluid can be economically delivered to most any area of a vehicle including abstract uses such as removing ice from a mud flap. The electrically operated solenoids secured to each manifold outlet operate to allow fluid flow from the reservoir style manifold through a selected manifold outlet.

Referring to FIG. 3, depicted is a flow through style manifold 70 formed from a housing 72 having a Chamberan inlet 74, upper outlet 76, central outlet 78 and lower outlet 80. Flange tabs 82 and 84 illustrate the flexibility in mounting the manifold using mounting holes 86 to facilitate securement of the manifold. Similar to the reservoir style manifold, the outlets may have different diameters depending on the flow rate required for each item serviced. The manifold is constructed from two piece injection molded members. The backside of the ports can be bell mouthed for flow. Exit ports can be molded on both halves to improve directionality. Multiple port sizes allow for different flow rates without the need for flow restrictors. In the preferred embodiment, the manifold employs individual solenoids.

The instant invention further allows for simplicity in installation, wherein a single pump can be activated by any item that requests fluid washing. For instance, if a rear window is in need of fluid washing, the pump and associated solenoid can be operated. If a headlight is in need of fluid washing, the pump and associated solenoid valve can be operated. This eliminates the need for wiring to individual pumps, and replaces individual pump tubing with electrical solenoid wiring.

In an alternative embodiment, a valve may be used with multiple linear positions that distribute the fluid to the proper port. Still another embodiment could employ a rotary distribution system using a stepper motor or servo to align the pumped fluid to the item to be cleaned.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and drawings/figures.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention. Although the invention has been described in connection with specific preferred embodiments, it should be understood that the invention should not be unduly limited to such specific embodiments.

What is claimed is:

1. A vehicle washer reservoir system for a vehicle comprising:
a reservoir forming an interior chamber with a reservoir inlet permitting insertion of washing fluid within said chamber and a reservoir outlet;
a pump coupled to said reservoir outlet, said pump drawing washing fluid from said chamber upon activation for pressurized delivery;
a manifold fluidly coupled to an outlet of said pump, said manifold having at least outlet constructed and arranged to deliver said pressurized washing fluid to a windshield and at least one additional outlet constructed and arranged to deliver washing fluid to another location on the vehicle that benefits from being rinsed with washing fluid; and
a electrically operated solenoid secured to each said manifold outlet wherein said solenoid is operated to allow fluid flow from said reservoir through a selected manifold outlet.

2. The washer system according to claim 1 wherein said manifold contains a cavity including a capacitor bladder.

3. The washer system according to claim 1 wherein said manifold outlets are sized to limit the flow of fluid through each said outlet.

4. The washer system according to claim 3 wherein at least one said manifold outlet has a different diameter than an adjoining manifold outlet.

5. The washer system according to claim 1 wherein at least one manifold outlet is bell mouthed.

6. The washer system according to claim 1 wherein said manifold including mounting tabs.

7. The washer system according to claim 1 including a check valve positioned after said pump to prevent backflow of washer fluid into said reservoir.

8. A washer system for a vehicle comprising:
a reservoir forming an interior chamber with a reservoir inlet permitting insertion of washing fluid within said chamber and a reservoir outlet;
a pump coupled to said reservoir outlet, said pump drawing washing fluid from said chamber upon activation for pressurized delivery;
a linear valve manifold fluidly coupled to an outlet of said pump, said linear valve manifold having at least one outlet constructed and arranged to deliver washing fluid to a windshield and at least one second outlet constructed and arranged to deliver washing fluid to a location on the vehicle that benefits from being rinsed with washing fluid;
wherein said valve may be used with multiple linear positions to distribute the fluid to each said outlet.

9. The washer system according to claim 8 wherein said manifold including mounting tabs.

10. The washer system according to claim 8 including a check valve positioned after said pump to prevent backflow of washer fluid into said reservoir.
